(19) United States
(12) Patent Application Publication
(10) Pub. No.: US 2007/0111021 A1
(43) Pub. Date: May 17, 2007

(54) Black colored steel sheet

(75) Inventors: Hiroki Nakamaru, Hiroshima (JP); Yuzo Otsuka, Chiba (JP); Hiroyuki Ogata, Chiba (JP); Shigeru Umino, Chiba (JP); Chiyoko Tada, Chiba (JP)

Correspondence Address: YOUNG & THOMPSON, 745 SOUTH 23RD STREET, 2ND FLOOR, ARLINGTON, VA, 22202, US

(73) Assignee: JFE Steel Corporation, Tokyo (JP)

(21) Appl. No.: 10/580,907

(22) PCT Filed: May 27, 2004
(86) PCT No.: PCT/JP04/07643

§ 371 Date: May 30, 2006

(30) Foreign Application Priority Data
Dec. 1, 2003 (JP) 2003-401642

(51) Int. Cl. B32B 15/08; B32B 15/00

(52) U.S. Cl. 428/626; 428/659; 428/679

(57) ABSTRACT

A black colored steel sheet has a Zn—Ni plating steel sheet which is processed by blackening treatment and a coating film formed on a surface of the Zn—Ni plating steel sheet by applying a paint composition which contains (a) metal ions, (b) a water soluble organic resin, (c) a water dispersible organic resin, (d) a glycoluril resin, and (e) an acid.

### TECHNICAL FIELD

The present invention relates to a black colored steel sheet, and more particularly, relates to a black colored steel sheet which is formed using a paint composition containing no chromium, which has superior corrosion resistance, which causes no reduction in gloss and no change in color tone, such as yellowing, greening, and whitening, and which also has superior scratch resistance, fingerprint resistance, solvent resistance, and electromagnetic shielding properties.

### BACKGROUND ART

Heretofore, black colored steel sheets having a surface processed by blacking treatment have been widely used, for example, for business machines such as personal computers and copy machines, home appliances such as air conditioners, automobile parts, and interior building materials. The black colored steel sheets may be manufactured by applying a black paint onto a surface of a zinc-based plating steel sheet or by performing blackening treatment, such as anode electrolysis, cathode treatment, alternating electrolysis, or anodization, on a surface of a Zn—Ni plating steel sheet. However, in the former case, in order to sufficiently cover an underlayer, the thickness of a coating film must be increased, and when the coating film is damaged in press molding, the corrosion resistance is degraded. In the latter case, since the gloss cannot be obtained just after the blackening treatment step, and in addition, the corrosion resistance is also inferior, chromate treatment must be performed, followed by clear coating, or a resin/chromate mixed type paint must be applied.

In the case in which the chromate coating film or the coating film obtained by applying a resin/chromate chemical liquid is used, the corrosion resistance and film adhesion are superior; however, since containing hexavalent chromium, specific wastewater treatment must be carried out in compliance with the clean water act in a chromate coating step, and as a result, the cost is disadvantageously increased. Furthermore, it has not been possible to prevent the change in color tone of a steel sheet surface, such as yellowing or greening, which is caused by the presence of chromium ions. Hence, in order to prevent the generation of white rust on a steel sheet, in particular, on a zinc-based plating steel sheet, surface treatment technique without using chromium has been pursued, and for example, many proposals have been made as follows.

(1) A metal surface treating method has been proposed comprising the step of coating a metal with a layer having a composition which contains (a) an anion component composed of at least four fluorine atoms and at least one element such as titanium or zirconium, (b) a cation component such as cobalt or magnesium, (c) a free acid for pH adjustment, and (d) an organic resin, but which does not contain chromium (for example, see Japanese Unexamined Patent Application Publication No. 5-195244).

(2) A composition of a metal surface treatment agent has been proposed which contains (a) a copolymer containing a hydroxyl group, (b) phosphoric acid and (c) a metal phosphate of copper, cobalt, iron, manganese, or the like, but which does not contain chromium (for example, see Japanese Unexamined Patent Application Publication No. 9-241856).

(3) A composition of a surface treatment agent has been proposed which contains (a) a resin containing poly(hydroxy ether) segments and copolymer segments of unsaturated monomers, (b) phosphoric acid and (c) a metal phosphate of calcium, cobalt, iron, manganese, zinc or the like, but which does not contain chromium (for example, see Japanese Unexamined Patent Application Publication No. 11-50010).

(4) An aqueous surface treatment agent has been proposed which contains (a) polyvalent metal ions of manganese, cobalt, zinc or the like, (b) an acid such as a fluoro acid, phosphoric acid, or acetic acid, (c) a silane coupling agent, and (d) a water soluble polymer having 2 to 50 polymer units dissolved in an aqueous solvent (for example, see Japanese Unexamined Patent Application Publication No. 11-106945).

In the above (1) to (4) methods, when a sufficient amount of the surface treatment agent (paint) is applied onto a metal sheet, that is, when a coating film having a sufficient thickness is formed, passable corrosion resistance can be obtained; however, for example, when a coating film is formed so that a protruding portion or the like of the metal sheet is partly exposed, or when the film thickness is excessively small, the corrosion resistance is seriously inferior. That is, only when the coverage of the metal sheet with the surface treatment agent is 100%, the corrosion resistance can be obtained; however, when the coverage is less than 100%, the corrosion resistance is not sufficient. On the other hand, when the entire surface is covered with a thick coating film, problems such as whitening of the appearance after press molding and/or degradation of electromagnetic shielding properties occur in some cases.

In all the above conventional techniques (1) to (4), a phosphate is used; however, when a phosphate compound in the form of a solid remains in the coating film after drying, there has been a problem of change in color tone of a steel sheet surface, and in particular, there has been a problem of serious change in degree of gloss and/or degree of whiteness.

As a method for solving the above problems, a method has been proposed in which a paint composition containing metal ions, a water soluble organic resin in a specific amount, a water dispersible organic resin, and an acid is applied to a Zn—Ni plating steel sheet processed by blackening treatment for forming a coating film (Japanese Unexamined Patent Application Publication No. 2001-164377). According to this method, the above problems can be reliably solved; however, in the case in which the coating film is not sufficiently cured, when the surface is wiped with a solvent such as an alcohol, there has been a problem of the change in color.

### DISCLOSURE OF INVENTION

An object of the present invention is to provide a black colored steel sheet having a surface treatment film which requires no specific wastewater treatment when a surface treatment agent (paint) is applied and when the black colored steel sheet obtained thereby is used, which reduces defects of a conventional black colored steel sheet, and which has superior corrosion resistance. Furthermore, in addition to a small change in color tone of a steel sheet surface after blackening treatment, no reduction in gloss, and superior scratch resistance and fingerprint resistance, the above black colored steel sheet has superior solvent resistance and electromagnetic shielding properties.

The inventor of the present invention found that when a paint composition, which contains no chromium, including metal ions, a water soluble organic resin, a water dispersible organic resin, a glycoluril resin, and an acid is applied to a blackening treated surface of a Zn—Ni plating steel sheet to form a coating film having an extremely small thickness, the corrosion resistance, scratch resistance, fingerprint resistance, solvent resistance and electromagnetic shielding properties are improved, and the color tone and gloss can also be ensured, so that as a result, the present invention was made.

The present invention provides a black colored steel sheet comprising a Zn—Ni plating steel sheet which is processed by blackening treatment and a coating film formed on a surface of the Zn—Ni plating steel sheet by applying a paint composition which contains (a) metal ions, (b) a water soluble organic resin, (c) a water dispersible organic resin, (d) a glycoluril resin, and (e) an acid.

The metal ions (a) in the paint composition are preferably at least one type selected from the group consisting of Al ions, Mg ions, and Mn ions. In addition, the above metal ions (a) may include at least one type selected from the group consisting of Al ions, Mg ions, and Mn ions and ions of at least one metal selected from the group consisting of Zn, Co, Ti, Sn, Ni, Fe, Zr, Sr, Y, Nb, Cu, Ca, V, and Ba. The addition amount of the metal ions (a) is preferably in the range of 0.1 to 50 mass percent to the total of the metal ions (a), the water soluble organic resin (b), the water dispersible organic resin (c), the glycoluril resin (d), and the acid (e).

The water soluble organic resin (b) in the paint composition preferably includes at least one type of polymer of a monomer containing a carboxyl group and/or at least one type of copolymer of a monomer containing a carboxyl group and another polymeric monomer. The addition amount of the water soluble organic resin (b) is preferably in the range of 0.1 to 20 mass percent to the total of the metal ions (a), the water soluble organic resin (b), the water dispersible organic resin (c), the glycoluril resin (d), and the acid (e).

The amount of the water dispersible resin (c) which is added to the paint composition is preferably in the range of 40 to 80 mass percent to the total of the metal ions (a), the water soluble organic resin (b), the water dispersible organic resin (c), the glycoluril resin (d), and the acid (e).

The amount of the glycoluril resin (d) which is added to the paint composition is preferably in the range of 1 to 40 mass percent to the total of the metal ions (a), the water soluble organic resin (b), the water dispersible organic resin (c), the glycoluril resin (d), and the acid (e).

The acid (e) in the paint composition is preferably at least one selected from the group consisting of phosphoric acid, acetic acid, nitric acid, hydrofluoric acid, and vanadic acid. The above acid (e) may include an organic acid which can be coordinated with a metal of bivalence or more and at least one selected from the group consisting of phosphoric acid, acetic acid, nitric acid, hydrofluoric acid, and vanadic acid. The addition amount of the acid (e) is preferably in the range of 1 to 20 mass percent to the total of the metal ions (a), the water soluble organic resin (b), the water dispersible organic resin (c), the glycoluril resin (d), and the acid (e).

The coating film formed by applying the paint composition preferably has a thickness of 0.1 to 3 μm.

The black colored steel sheet of the present invention is a so-called pollution-free non-chromate surface treated steel sheet containing no chromium and, in particular, is a black colored steel sheet having superior corrosion resistance, color tone, gloss, bending resistance, blocking resistance, scratch resistance, fingerprint resistance, solvent resistance, and electromagnetic shielding properties.

### BRIEF DESCRIPTION OF THE DRAWINGS

FIG. 1 is a block diagram for measuring leak noise from a flat electromagnetic shielding material.

FIG. 2 is a graph showing an example of noise measured under open condition in which a sample is not provided on an Al casing of a device shown in FIG. 1.

FIG. 3 is a graph showing a measurement example obtained when an electrolytic tin plate, which is practically used, is used as a test piece.

FIG. 4 is a graph showing a measurement example of Example 8.

FIG. 5 is a graph showing an example of exterior noise measured under open condition in which a sample is not provided on the Al casing of the device shown in FIG. 1 and in which high frequency is not generated.

### BEST MODE FOR CARRYING OUT THE INVENTION

In the present invention, when a paint composition which contains (b) a water soluble organic resin, (c) a water dispersible organic resin, (d) a glycoluril resin, (a) metal ions, and (e) an acid is applied to a surface of a Zn—Ni plating steel sheet which is processed by blackening treatment, a coating film is formed on the plating layer, the coating film having superior solvent resistance and electromagnetic shielding properties in addition to superior corrosion resistance, scratch resistance, fingerprint resistance, and color tone.

When the water soluble organic resin (b), the water dispersible organic resin (c), the glycoluril resin (d), and the acid (e) are compounded whit the metal ions (a) and preferably with a plurality of types of specific metal ions and a specific acid, as a result, the coating film as described above is formed by reaction of the metal ions with the water soluble organic resin and the plating layer.

As the blackening treatment of a Zn—Ni plating steel sheet, there are anode electrolysis treatment, cathode treatment, alternating electrolysis treatment, and anodization, and in particular, anode electrolysis is preferably used since the cost is inexpensive and superior degree of blackness is obtained.

In the present invention, since being added to the paint composition, the water soluble organic resin (b) permeates minute irregularities on the plating layer surface, and as a result, superior corrosion resistance can be obtained.

As the water soluble organic resin (b) added to the paint composition, any water soluble organic resin may be used; however, in particular, the water soluble organic resin (b) is preferably at least one selected from the group consisting of a polymer of a monomer containing a carboxyl group and a copolymer of a monomer containing a carboxyl group and another polymeric monomer. That is, the water soluble organic resin (b) is one of at least one type of polymer, at least one type of copolymer, and a mixture of at least one type of polymer and at least one type of copolymer.

As the monomer containing a carboxyl group, for example, an ethylenic unsaturated carboxylic acid and its derivatives may be mentioned. As the ethylenic unsaturated carboxylic acid, for example, there may be mentioned a monocarboxylic acid such as acrylic acid, methacrylic acid, or crotonic acid, and a dicarboxylic acid such as itaconic acid, maleic acid, or fumaric acid. As the above derivatives, for example, an alkaline metal salt, an ammonium salt, and an organic amine salt may be mentioned. Preferables are derivatives of acrylic acid and methacrylic acid.

As the monomer forming a copolymer with a polymer containing a carboxyl group, for example, there may be mentioned monomers containing a hydroxyl group, various acrylates, methacrylates, aromatic vinyl compounds, vinyl ester compounds, and other vinyl compounds, and in addition, a vinyl compound containing a sulfonic acid group and a vinyl compound containing a phosphate group may also be used. As preferable monomers, for example, there may be mentioned styrene and methacrylates such as butyl methacrylate and methyl methacrylate.

In addition, a monomer containing a carboxyl group which is copolymerized with or added to a (co)polymer of (meth)acrylates, an epoxy resin, an ester modified epoxy resin, a urethane modified epoxy resin, or the like may also be used.

In the case of the copolymer of a monomer containing a carboxyl group and another polymeric monomer, the content of the monomer containing a carboxyl group is preferably 0.5 mass percent or more of the total copolymer. When the content of the monomer containing a carboxyl group is 0.5 mass percent or more, the denseness of the coating film is increased, and as a result, the corrosion resistance is improved.

In addition, the mass average molecular weight of the polymer or copolymer is not particularly limited but is approximately ten thousand to several tens of thousands.

The amount (mass percent) of the water soluble organic resin (b) added to the paint composition, that is, the water soluble organic resin (b)/{the metal ions (a)+the water soluble organic resin (b)+the water dispersible organic resin (c)+the glycoluril resin (d)+the acid (e)}, is preferably 0.1 to 20 mass percent. When the amount is less than 0.1 mass percent, sufficient corrosion resistance is liable not to be obtained, and when the amount is more than 20 mass percent, pH of the total paint composition decreases, so that the pH is liable not to be easily adjusted to an appropriate value. The addition amount is preferably in the range of 1 to 10 mass percent and particularly preferably in the range of 3 to 8 mass percent.

In addition, when components other than the metal ions (a), the water soluble organic resin (b), the water dispersible organic resin (c), the glycoluril resin (d), and the acid (e) are contained in the paint composition, the amount of the water soluble organic resin (b) added to the total amount including the above components is preferably in the range described above.

In the present invention, by the addition of the water dispersible organic resin (c) to the paint composition, the change in color tone and reduction in gloss caused by application of the paint composition can be prevented.

As the water dispersible organic resin (c) which is added to the paint composition of the present invention, any water dispersible organic resin may be used; however, in particular, an organic resin described below which can be stably dispersed in the paint composition in an appropriate pH region is preferably used. For example, a polyester-based, an acrylic, and a urethane-based material which have been used for conventional surface treatment of metal materials may be mentioned. These materials may be used in combination.

In addition, the average particle diameter of the water dispersible organic resin (c) is preferably 1 μm or less. The reason for this is that when the average particle diameter is more than 1 μm, even after the water dispersible organic resin is dried to form a film, irregularities remain on the film surface, and as a result, the degree of gloss is reduced. The average particle diameter of the present invention indicates a particle diameter at a 50% cumulative frequency in volume fraction measured by a laser diffraction particle analyzer.

The glass transition temperature (Tg) of the water dispersible organic resin (c) is preferably in the range of 20 to 100° C. The reasons for this are as follows. When Tg is less than 20° C., the blocking resistance is inferior even after the coating film is dried, and when Tg is more than 100° C., since the coating film cannot follow the deformation of a steel sheet which occurs in machining, the coating film is broken, and as a result, the corrosion resistance becomes inferior after the machining.

The amount (mass percent) of the water dispersible organic resin (c) added to the paint composition, that is, the water dispersible organic resin (c)/{the metal ions (a)+the water soluble organic resin (b)+the water dispersible organic resin (c)+the glycoluril resin (d)+the acid (e)}, is preferably in the range of 40 to 80 mass percent. When the addition amount is less than 40 mass percent, the change in color tone caused by application of the paint composition is liable to occur, and on the other hand, when the addition amount is more than 80 mass percent, the corrosion resistance is liable to be degraded. The addition amount is preferably in the range of 45 to 70 mass percent and more preferably in the range of 50 to 60 mass percent.

In addition, when components other than the metal ions (a), the water soluble organic resin (b), the water dispersible organic resin (c), the glycoluril resin (d), and the acid (e) are contained in the paint composition, the addition amount of the water dispersible organic resin (c) to the total amount including the above components is preferably in the range described above.

In the present invention, when the glycoluril resin (d) is added to the paint composition, the solvent resistance is improved. The glycoluril resin includes derivatives obtained by addition of methylol or butylol to all or part of 1-, 3-, 4-, and 6-amino groups of glycoluril; alkyl etherified derivatives in which the alkyl indicates methyl, methyl/ethyl, butyl, and the like; oligomers formed by condensation with a methylol group or the like; and alkyl derivatives thereof. Preferables are tetramethylolated glycoluril and its oligomers.

The amount (mass percent) of the glycoluril resin (d) added to the paint composition, that is, the glycoluril resin (d)/{the metal ions (a)+the water soluble organic resin (b)+the water dispersible organic resin (c)+the glycoluril resin (d)+the acid (e)}, is preferably in the range of 1 to 40 mass percent and particularly preferably in the range of 10 to 30 mass percent. When the addition amount is less than the above range, the solvent resistance becomes insufficient, and when the addition amount is more than the above range, the coating film becomes brittle, so that the corrosion resistance is liable to be degraded.

In addition, when components other than the metal ions (a), the water soluble organic resin (b), the water dispersible organic resin (c), the glycoluril resin (d), and the acid (e) are contained in the paint composition, the addition amount of the glycoluril resin (d) to the total amount including the above components is preferably in the range described above.

In the present invention, when the metal ions (a) are added to the paint composition, a dense metal salt layer is formed on the plating layer surface, the surface is passivated, and as a result, superior corrosion resistance can be obtained. Accordingly, since the thickness of the coating film can be decreased, and the amount of the organic resin component having inferior conductivity can be decreased, the electromagnetic shielding properties can be improved.

As the metal ions (a) added to the paint composition of the present invention, any metal ions may be used, and in particular, ions of a metal such as Al, Mg, Mn, Zn, Co, Ti, Sn, Ni, Fe, Zr, Sr, Y, Nb, Cu, Ca, V, or Ba are preferably used. More preferably, the metal ions (a) are at least one type selected from the group consisting of Al ions, Mg ions, and Mn ions. The reasons these three types of metal ions are preferable are as follows. In film formation, pseudo-crosslinking reaction is allowed to occur in a wide pH range to form a dense coating film, so that sufficient corrosion resistance is obtained even when the film thickness is small. In addition, at the same time, superior scratch resistance, fingerprint resistance and the like can be obtained, and compared to the case in which the above three types of metal ions are not contained, the corrosion resistance can be significantly improved. In particular, in combination with the organic resin containing a carboxyl group, the effects are further improved.

As the metal ions, in addition to at least one type selected from the group consisting of Al ions, Mg ions, and Mn ions, at least one type of ions of a metal selected from the group consisting of Zn, Co, Ti, Sn, Ni, Fe, Zr, Sr, Y, Nb, Cu, Ca, V, and Ba is preferably added. More preferable is the case in which Zn ions are further added to Al ions, Mg ions, and Mn ions, and compared to the case in which the above Al ions, Mg ions, and Mn ions are contained, more superior corrosion resistance can be obtained.

The above metal ions may be supplied by dissolving a phosphate, nitrate, carbonate, sulfate, acetate, a salt of fluoride or the like, oxide, hydroxide, or metal. The metal ions are preferably supplied in the form of an aqueous solution of phosphates, nitrates, carbonates, sulfates, acetates, and hydroxides of Al, Mg, and Mn, and in the form of an aqueous solution of a phosphate and acetate of Zn. The acids forming the above metal salts may also be used as a supply source for the acid (e) which is the component of the paint composition of the present invention.

The amount (mass percent) of the metal ions (a) added to the paint composition, that is, the metal ions (a)/{the metal ions (a)+the water soluble organic resin (b)+the water dispersible organic resin (c)+the glycoluril resin (d)+the acid (e)}, is preferably in the range of 0.1 to 50 mass percent and particularly preferably in the range of 0.1 to 20 mass percent. When the addition amount is less than 0.1 mass percent, the corrosion resistance is liable to be degraded, and when the addition amount is more than 50 mass percent, the weldability is liable to be degraded. When a plurality of metal salts is used, the amount of each metal salt is preferably set in the range of 0.5 to 40 mass percent. The addition amount of the metal ions is calculated as the content in a solid component which is obtained after sufficiently removing a water component by drying from the amount of the paint composition measured in preparation.

In addition, when components other than the metal ions (a), the water soluble organic resin (b), the water dispersible organic resin (c), the glycoluril resin (d), and the acid (e) are contained in the paint composition, the addition amount of the metal ions (a) to the total amount including the above components is preferably in the range described above.

In the present invention, when the acid (e) is added to the paint composition, since the surface of the steel sheet processed by blackening treatment is etched, and the adhesion between a coating film formed from the paint composition and the steel sheet is further improved, the coating film is prevented from being peeled away, and hence the corrosion resistance is improved. In addition, the acid (e) also has an effect of adjusting pH of the paint composition to an appropriate value. As the acid (e) added to the paint composition of the present invention, any acid may be used, and in particular, an acid selected from the group consisting of phosphoric acid, acetic acid, nitric acid, hydrofluoric acid, and vanadic acid is preferably used. As described above, the acid may be supplied in the form of a metal salt.

The appropriate pH of the paint composition of the present invention is in the range of 1.0 to 6.5. When the pH is less than 1.0, the plating layer is vigorously dissolved in application of the paint composition, and as a result, the corrosion resistance is liable to be degraded. When the pH is more than 6.5, the paint composition becomes unstable, and precipitates may be generated in some cases. The pH is preferably in the range of 4.0 to 6.0 and more preferably in the range of 4.5 to 5.5.

The amount of the acid (e) added to the paint composition is not particularly limited; however, the addition amount (mass percent) in the paint composition, that is, the acid (e)/{the metal ions (a)+the water soluble organic resin (b)+the water dispersible organic resin (c)+the glycoluril resin (d)+the acid (e)}, is in the range of 1 to 20 mass percent and preferably in the range of 5 to 15 mass percent. When the addition amount is less than 1 mass percent, since the pH cannot be adjusted to an appropriate value, etching of the steel sheet processed by blackening treatment cannot be sufficiently performed, and as a result, the corrosion resistance is liable to be degraded. On the other hand, when the amount is more than 20 mass percent, dissolution of the steel sheet processed by blackening treatment is excessively fast, and as a result, appearance irregularities are liable to be generated. The addition amount of the acid is calculated as the content in a solid component which is obtained after sufficiently removing a water component by drying from the amount of the paint composition measured in preparation.

In addition, when components other than the metal ions (a), the water soluble organic resin (b), the water dispersible organic resin (c), the glycoluril resin (d), and the acid (e) are contained in the paint composition, the addition amount of the acid (e) to the total amount including the above components is preferably in the range described above.

In the present invention, since the corrosion resistance is improved by appropriate combination among the metal ions (a), the glycoluril resin (d), and the acid (e), the thickness of the coating film can be decreased, the organic resin component can be decreased, and as a result, the electromagnetic shielding properties can be improved.

In addition, as the acid, an organic acid (f) which can be coordinated with a metal of bivalence or more may also be used. In particular, when at least one type of the above organic acid is further used together with the five types of acids described above, the corrosion resistance of a coating film to be formed thereby is further improved. In addition to promotion of etching of the steel sheet processed by blackening treatment, since the above organic acid is coordinated with the metal ions, the coating film is further densified. As the organic acid (f), for example, oxalacetic acid, tricarballylic acid, citric acid, isocitric acid, succinic acid, malic acid, or glutaric acid may be mentioned. The amount of the organic acid (f) added to the paint composition is not particularly limited; however, the amount in the paint composition, that is, the organic acid (f)/{the metal ions (a)+the water soluble organic resin (b)+the water dispersible organic resin (c)+the glycoluril resin (d)+the acid (e)+the organic acid (f)}, is preferably in the range of 1 to 10 mass percent. When the addition amount is less than 1 mass percent, since the effect is not sufficient, the number of uncrosslinked points is increased, and as a result, the densification of the coating film may be adversely interfered with in some cases. On the other hand, when the amount is more than 10 mass percent, the stability as the paint composition may not be retained in some cases.

In order to increase the denseness of the coating film of the present invention, a metal oxide may be added to the paint composition. The metal oxide is preferably at least one selected from the group consisting of SiO₂, MgO, ZrO₂, Al₂O₃, SnO₂, Sb₂O₃, Fe₂O₃, and Fe₃O₄.

When the metal oxide is used in an amount which is approximately equivalent to that conventionally added to a paint composition used for surface finishing treatment of a metal material, a sufficient effect can be obtained.

In order to impart other properties to the paint composition of the present invention, wax and/or other various additives which are generally used may be contained.

After being dissolved or dispersed in an aqueous medium, the paint composition of the present invention is used. The aqueous medium is water or a mixed medium of an organic solvent or an inorganic solvent, which can be mixed with water. The mixing ratio of the mixed medium is not particularly limited. As the organic solvent, butyl cellosolve is preferably used. The solution or the dispersion is adjusted so that the content of the additive component is in the range of 5 to 40 mass percent and is preferably in the range of 10 to 30 mass percent.

In order to manufacture the black colored steel sheet of the present invention, after the paint composition described above is applied to a steel sheet having a Zn—Ni plating surface processed by blackening treatment, the paint composition is compressed by ringer rollers or the like and is then preferably dried by heating, so that the coating film is formed. For applying the paint composition, methods such as roll coating, spray coating, brush coating, immersion coating, and curtain flow may also be used.

The thickness of the coating film to be formed is preferably in the range of 0.1 to 3 μm (after coating film formation) and more preferably in the range of 0.5 to 1.5 μm (after coating film formation). When the thickness is less than 0.1 μm, the coating film cannot cover the entire steel sheet processed by blackening treatment, and as a result, the corrosion resistance is liable to be degraded. On the other hand, when the thickness is more than 3 μm, after press molding, the appearance is turned into white or film cracking occurs at a bent portion, and in addition, the electromagnetic shielding properties are liable to be degraded.

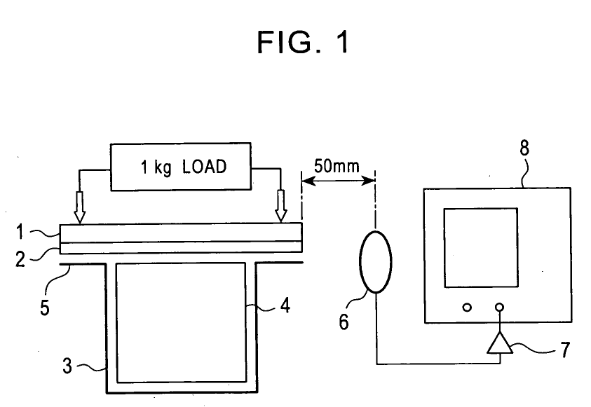

In addition, the electromagnetic shielding properties of the present invention are preferably evaluated by measuring leak noise as shown in FIG. 1.

In an Al casing 3 having a size of 100 mm×100 mm×100 mm formed from an aluminum plate having a thickness of 2 mm, a clock 4 of 20 MHz is placed as an oscillation source and a high frequency of 20 to 1,000 MHz is output every 20 MHz.

The upper surface of the Al casing 3 is an open portion of 100 mm by 100 mm, and a flange 5 having a length of 20-mm is formed around the side surfaces, so that the upper surface of the Al casing which is to be brought into contact with an evaluation surface of a sample has a picture frame shape having exterior dimensions of 140 mm by 140 mm and a width of 20 mm. Sample 1 (having a plate thickness of approximately 0.7 mm) is cut to have a size of 140 mm by 140 mm and is then placed so that an evaluation surface 2 which is regarded as the bottom surface is brought into contact with the upper surface of the Al casing 3. Subsequently, a constant pressure of 1 kg is applied to sample 1 downward in the vertical direction. In this case, the evaluation surface 2 is one side surface of sample 1 and is a surface to which the paint composition of the present invention is applied.

After an electromagnetic wave leaked from a mating face having a picture frame shape between the Al casing 3 and sample 1 which is in contact therewith is received by a loop antenna 6 having a diameter of 30 mm at a position of 50 mm apart from the flange 5, followed by amplification using a preamplifier 7 of 25 dB, analysis is performed using a spectrum analyzer (R3162 manufactured by Advantest Corp.) 8.

### EXAMPLES

Hereinafter, the present invention will be described in detail with reference to the following examples.

### Examples 1 to 29

To the following steel sheets A to C, each of which is a Zn—Ni plating steel sheet processed by blackening treatment, aqueous paint compositions (total addition concentration: 20 mass percent) were applied by roll coating, the paint compositions being obtained by adding the following water soluble organic resins A to D, 5 types of metal salts (meal ion patterns A to I), acids A to E, organic acids A to C, water dispersible organic resins A to C, and glycoluril resins A to D in accordance with ratios shown in Table 1 to deionized water, followed by mixing. Subsequently, heating was performed so that the temperature of each steel sheet reached 170° C. within 15 seconds for drying and curing to form coating films having a predetermined thickness, thereby obtaining test pieces of black colored steel sheets.

Black Colored Steel Sheets A to C

Sheet A: Anode electrolysis-treated steel sheet (sheet thickness: 0.7 mm)

Sheet B: Cathode treated steel sheet (sheet thickness: 0.7 mm)

Sheet C: Alternating electrolysis-treated steel sheet (sheet thickness: 0.7 mm)

Water Soluble Organic Resins A to D

The values of the resins A to D indicate a mass ratio between polymer units forming a copolymer.

Resin A: Acrylic acid/maleic acid=90/10 (mass average molecular weight: 20,000)

Resin B: Acrylic acid/itaconic acid=70/30 (mass average molecular weight: 15,000)

Resin C: Methacrylic acid/itaconic acid=60/40 (mass average molecular weight: 25,000)

Resin D: Butyl methacrylate/acrylic acid/2HBA=20/40/40 (mass average molecular weight: 30,000), 2HBA being 2-hydroxybutyl acrylate.

Glycoluril Resins A to D

Resin A: Fully butylated glycoluril resin (“Cymel 1170” manufactured by Mitsui Cytec Ltd.)

Resin B: Alkylated (methylated and ethylated) glycoluril resin (“Cymel 1171” manufactured by Mitsui Cytec Ltd.)

Resin C: Tetramethylolated glycoluril resin (“Cymel 1172” manufactured by Mitsui Cytec Ltd.)

Resin D: Fully methylated glycoluril resin (“Cymel 1174” manufactured by Mitsui Cytec Ltd.)

Metal Ions A to I:

The values of patterns are each mass ratio of metal ions. In the examples, Me indicates ions of a metal which is used in addition to ions of Mg, Mn, and Al, and Me₁ and Me₂ indicate ions of two metals which are used in addition to ions of Mg, Mn, and Al.

Pattern A: Mg²⁺/Mn²⁺/Al³⁺/Meⁿ⁺=1/1/1/0

Pattern B: Mg²⁺/Mn²⁺/Al³⁺/Meⁿ⁺=1/1/1/1

Pattern C: Mg²⁺/Mn²⁺/Al³⁺/Meⁿ⁺=2/1/1/1

Pattern D: Mg²⁺/Mn²⁺/Al³⁺/Me₁ⁿ⁺/Me₂ⁿ⁺=1/1/1/1/1

Pattern E: Mg²⁺/Mn²⁺/Al³⁺/Me₁ⁿ⁺/Me₂ⁿ⁺=2/1/1/1/1

Pattern F: Mg²⁺/Mn²⁺/Al³⁺/Meⁿ⁺=1/1/0/0

Pattern G: Mg²⁺/Mn²⁺/Al³⁺/Me₁ⁿ⁺/Me₂ⁿ⁺=0/1/0/1/1

Pattern H: Mg²⁺/Mn²⁺/Al³⁺/Meⁿ⁺=0/0/0/1

Pattern I: Mg²⁺/Mn²⁺/Al³⁺/Meⁿ⁺=0/0/1/1

Metal Salts:

Salt A: Acetate

Salt P: Phosphate

Salt C: Carbonate

Salt N: Nitrate

H: Hydroxide

Type of Acid

A: Phosphoric acid

B: Acetic acid

C: Hydrofluoric acid

D: Nitric acid

E: Vanadic acid

Organic Acids A to C:

Organic acid A: Tricarballylic acid

Organic acid B: Citric acid

Organic acid C: Succinic acid

Water Dispersible Organic Resins A to C:

Emulsion A: Acrylic emulsion

Emulsion B: Polyester emulsion

Emulsion C: Urethane-epoxy emulsion

The following properties (flat-portion corrosion resistance, change in color tone, gloss value, blocking resistance, bending resistance, fingerprint resistance, scratch resistance, solvent resistance, and electromagnetic shielding properties) were measured for the test pieces thus prepared in accordance with the test methods described below.

<Flat-Portion Corrosion Resistance>

After the test piece was cut into a size of 50 mm by 100 mm, and the edge parts thereof were sealed, a salt spray test was performed for 48 hours in accordance with a neutral salt spray test of JIS Z2371-2000, and an area ratio of white rust generated thereby was evaluated in accordance with the following evaluation criteria. The results are shown in Table 2.

⊙: 5% or less

◯: more than 5% to 10%

Δ: more than 10% to 20%

x: more than 20%

<Change in Color Tone>

The change (ΔL*) in color tone (L*) before and after the application of the paint composition to the steel sheet surface was measured using a spectroscopic color-difference meter (“SQ2000” manufactured by Nippon Denshoku Industries Co., Ltd.), and evaluation was performed in accordance with the following evaluation criteria. The results are shown in Table 2.

⊙: ΔL* is less than 20.

Δ: ΔL* is in the range of 20 to 25.

x: ΔL* is more than 25.

<Gloss Value>

The 60-degree mirror surface gloss, which is defined by JIS K5600-4-7:1999, of the test piece was measured using a spectroscopic color-difference meter (“SQ2000” manufactured by Nippon Denshoku Industries Co., Ltd.), and evaluation was performed in accordance with the following evaluation criteria. The results are shown in Table 2.

⊙: the degree of mirror surface gloss is more than 10% to 30%.

Δ: the degree of mirror surface gloss is more than 5% to 10%.

x: the degree of mirror surface gloss is 5% or less.

<Blocking Resistance>

While two test pieces were being held together at a torque of 2.94×10⁵ N·m so that coating films thereof were in contact with each other, they were immersed in a constant-temperature bath at 40° C. for 6 hours. Subsequently, the test pieces were peeled away from each other, and depending on adhesion status observed when the peeling was performed, the blocking resistance was classified into three groups. The results are shown in Table 2.

⊙: no adhesion (peeling occurs by the own weight of the test piece.)

Δ: slight adhesion (no peeling occurs by the own weight of the test piece, but peeling can be easily performed.)

x: adhesion (peeling is not easily performed.)

<Bending Resistance>

After the test piece was cut by shearing into a size of 100 mm by 20 mm, and OT bending in which the test piece thus sheared was bent 180° was performed in accordance with JIS Z2248-1996, one visual field of the outside of the bent portion was observed with a material microscope (magnification of 20×), and the presence of cracks in the coating film was examined. The results are shown in Table 2.

⊙: no cracks

Δ: slightly cracked (cracking area of less than 20% in the width direction)

x: apparently cracked (cracking area of 20% or more in the width direction)

<Fingerprint Resistance>

The change in color tone (L value, a value, and b value) before and after the application of white Vaseline to the test piece was measured using a spectroscopic color-difference meter (“SQ2000” manufactured by Nippon Denshoku. Industries Co., Ltd.), and evaluation was performed by ΔE represented by the following equation in accordance with JIS Z8730-2002. The results are shown in Table 2.

⊙: ΔE is 1 or less.

◯: ΔE is more than 1 to 2.

Δ: ΔE is more than 2 to 3.

x: ΔE is more than 3.

$$Δ E = {( Δ {L}^{2} + Δ {a}^{2} + Δ {b}^{2} )}^{1 / 2}$$

$$Δ E = \sqrt{Δ {L}^{2} + Δ {a}^{2} + Δ {b}^{2}}$$

<Scratch Resistance>

A sliding test was performed for a test piece (20 mm×200 mm) at a load of 9.8 MPa, a sliding speed of 20 mm/sec, and a sliding temperature of 25° C., and subsequently, observation was performed with a material microscope (magnification of 20×). The results are shown in Table 2.

⊙: no scratches are observed (scratch area of less than 5% in the width direction).

◯: scratches are observed (scratch area of 5% to less than 20% in the width direction).

x: many scratches are observed (scratch area of 20% or more in the width direction).

<Solvent Resistance>

After a hammer having a metal portion of 500 g was wound with absorbent gauze permeated with ethanol, a surface of the test piece was rubbed with this hammer 100 times at a speed of one second per back-and-forth movement for a stroke of 50 mm. The amount of a resin on the surface of the test piece before and that after the above treatment were obtained from the C (carbon) count by measurement using fluorescent x-rays, so that the change in resin amount was examined. The results are shown in Table 2.

Measurement device: fluorescent x-ray analyzer, system 3270, manufactured by Rigaku Denki Kogyo K.K.

C count before operation: B (kcps)

C count after operation: A (kcps)

Determination: A/B>0.8: ⊙ acceptable
A/B≦0.8: x rejected

<Electromagnetic Shielding Properties>

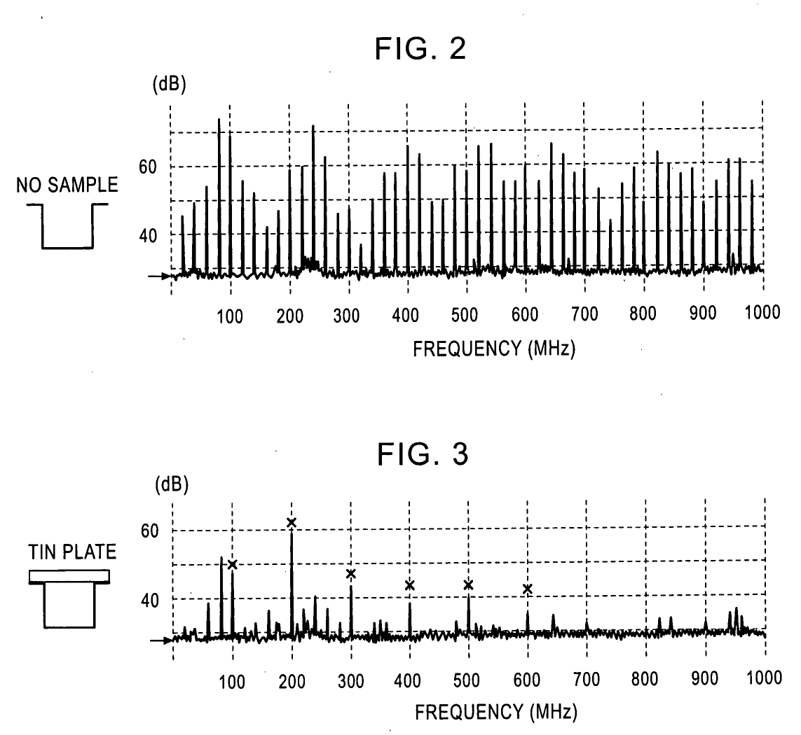

For the electromagnetic shielding properties, leak noise from the evaluation surface of the test piece is measured by a spectral analyzer using the device shown in FIG. 1, and charts shown in FIGS. 2 to 4 were obtained.

For the evaluation of examples and comparative examples, at every 20 MHz from a frequency of 20 MHz to 1,000 MHz, peaks having a difference of 3 dB or more from the background were read and were then converted by the following equation 2, so that a noise evaluation value (I) was obtained.
I=10·log(10^{0.1d1}+10^{0.1d2}+ - - - +10^{0.1dn})
Equation 2

n: the number of peaks having a difference of 3 dB or more from the background.

d1, d2, - - - dn: difference between the peak value and the background (limited to that having a difference of 3 dB or more).

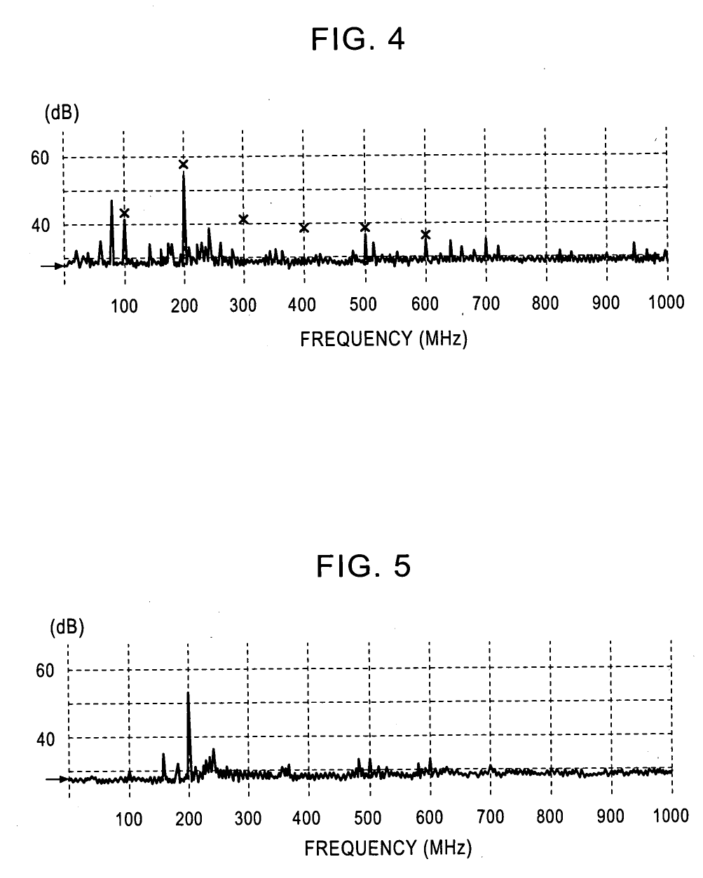

As the evaluation standard, a measurement example is shown in FIG. 3 in which an electrolytic tin plate (amount of tin plating: 2.8 g/m²) is used as a test piece which is currently believed to be most suitably used in the field in which high electromagnetic shielding properties are required and which has been used in practice, and a measurement example of Example 8 is shown in FIG. 4. In addition, an example is shown in FIG. 5 obtained when a high frequency is not generated and when a sample is not provided. FIG. 5 shows exterior noises. The differences between the peak values read from FIGS. 3 and 4 and the background (28 dB, shown by arrows in FIGS. 2 to 5) were read and were substituted into the above equation 2, and the calculation results were regarded as Io and I. In addition, since the peaks marked with x in FIG. 3 were derived from the exterior noises shown in FIG. 5, they were not applied to the above equation 2.

For each test material of the examples and comparative examples, the leak noise was measured, followed by measurement thereof, and the evaluation was performed such that I/Io≦1.2 regarded as ◯ and x, respectively. The results are shown in Table 2.

TABLE 1-1
COMPOSITION

| | | PAINT COMPOSITION | | | | | | |
|---|---|---|---|---|---|---|---|---|
| | | | | | | | | WATER DISPERSIBLE |
| | BLACK COLORED | METAL IONS (a) | | | | | WATER SOLUBLE | ORGANIC RESIN (c) |
| EXAMPLE | STEEL SHEET | Al | Mg | Mn | OTHER TYPES | PATTERN | ORGANIC RESIN (b) | TYPE |
| 1 | A | H | A | P | — | A | A | A |
| 2 | A | H | C | H | Zn—P | B | A | A |
| 3 | A | H | P | A | Zn—P | C | A | A |
| 4 | A | H | H | C | Zn—P Co— | D | A | A |
| 5 | A | H | A | P | Zn—P Ti—P | E | B | B |
| 6 | A | — | C | H | — | F | B | B |
| 7 | A | — | — | A | Zn—P Ni—P | G | B | C |
| 8 | A | N | H | C | Zn—P | B | B | C |
| 9 | B | H | — | — | Zn—P | I | B | C |
| 10 | C | N | C | H | Zn—P | B | B | A |
| 11 | A | H | P | A | Zn—P | B | B | A |
| 12 | A | H | H | C | Zn—P | B | B | A |
| 13 | A | H | A | P | Zn—P | B | B | A |
| 14 | A | H | C | H | Zn—P | B | B | B |
| 15 | C | — | — | — | Zn—P | H | C | B |
| 16 | A | H | H | C | Zn—P | B | D | C |
| 17 | A | H | C | H | Ti—P | B | B | C |
| 18 | A | H | P | A | Sr—P | B | B | C |
| 19 | A | H | H | C | — | A | B | C |
| 20 | A | H | C | P | Zn—P Co— | D | C | A |

| | PAINT COMPOSITION | | | | | |
|---|---|---|---|---|---|---|
| | WATER DISPERSIBLE | | | | | |
| | ORGANIC RESIN (c) | | | | | |
| | AVERAGE PARTICLE | | GLYCOLURIL | | ORGANIC | |
| EXAMPLE | DIAMETER (μm) | Tg (° C.) | RESIN (d) | ACID (e) | ACID (f) | REMARKS |
| 1 | 0.10 | 50 | A | A | A | INVENTION |
| 2 | 0.15 | 60 | B | A | B | EXAMPLE |
| 3 | 0.20 | 60 | C | A | C | |
| 4 | 0.40 | 50 | D | A | B | |
| 5 | 0.90 | 50 | A | A | A | |
| 6 | 0.80 | 60 | B | A | B | |
| 7 | 0.90 | 60 | C | A | C | |
| 8 | 0.50 | 60 | D | A | B | |
| 9 | 0.40 | 40 | A | A | — | |
| 10 | 0.14 | 40 | B | B | — | |
| 11 | 0.14 | 40 | C | C | — | |
| 12 | 0.15 | 50 | D | D | — | |
| 13 | 0.15 | 50 | A | A + E | — | |
| 14 | 0.30 | 50 | B | A + E | — | |
| 15 | 0.40 | 50 | C | A + E | — | |
| 16 | 0.90 | 50 | D | A + E | — | |
| 17 | 0.90 | 50 | C | A + E | — | |
| 18 | 0.90 | 50 | C | A + E | — | |
| 19 | 0.90 | 50 | C | A + E | — | |
| 20 | 0.50 | 40 | C | A + E | — | |

“—” indicates the content is zero.
In the case in which one type of metal ions is contained as one of the above other types, said one type of metal ions corresponds to the metal ions Me mentioned above. In the case in which two types of metal ions of the above other types are contained, said two types of metal ions correspond to the metal ions Me₁ and Me₂ mentioned above.

TABLE 1-2
COMPOSITION RATIO

| | COMPOSITION RATIO OF PAINT COMPOSITION | | | | | | | | |
|---|---|---|---|---|---|---|---|---|---|
| | | WATER | WATER | | | | | COATING | |
| | METAL | SOLUBLE | DISPERSIBLE | | | | | FILM | |
| | IONS | ORGANIC | ORGANIC | GLYCOLURIL | ACID | ORGANIC | | THICKNESS | |
| EXAMPLE | (a) | RESIN (b) | RESIN (c) | RESIN (d) | (e) | ACID (f) | d/b + c + d | (μm) | REMARKS |
| 1 | 1.778 | 5 | 78 | 9.222 | 5 | 1 | 0.10 | 1 | INVENTION |
| 2 | 2.615 | 5 | 42 | 43.385 | 5 | 2 | 0.48 | 1 | EXAMPLE |
| 3 | 8.571 | 7 | 50 | 24.429 | 6 | 4 | 0.30 | 1 | |
| 4 | 10.750 | 5 | 60 | 16.250 | 6 | 2 | 0.20 | 1 | |
| 5 | 2.667 | 7 | 60 | 22.333 | 6 | 2 | 0.25 | 1 | |
| 6 | 3.429 | 7 | 55 | 26.571 | 6 | 2 | 0.30 | 0.1 | |
| 7 | 4.857 | 6 | 55 | 26.143 | 6 | 2 | 0.30 | 1 | |
| 8 | 4.857 | 6 | 55 | 26.143 | 6 | 2 | 0.30 | 0.5 | |
| 9 | 8.667 | 6 | 55 | 20.333 | 10 | 0 | 0.25 | 1 | |
| 10 | 4.857 | 6 | 55 | 26.143 | 8 | 0 | 0.30 | 1 | |
| 11 | 5.857 | 6 | 55 | 26.143 | 7 | 0 | 0.30 | 1 | |
| 12 | 6.857 | 6 | 55 | 26.143 | 6 | 0 | 0.30 | 1 | |
| 13 | 7.857 | 6 | 55 | 26.143 | 4.5 + 0.5* | 0 | 0.30 | 2 | |
| 14 | 14.667 | 6 | 55 | 20.333 | 3.5 + 0.5* | 0 | 0.25 | 1 | |
| 15 | 2.576 | 6 | 55 | 31.424 | 4.5 + 0.5* | 0 | 0.34 | 1 | |
| 16 | 17.750 | 6 | 55 | 17.250 | 3.6 + 0.4* | 0 | 0.22 | 1 | |
| 17 | 14.111 | 6 | 65 | 7.889 | 6.3 + 0.7* | 0 | 0.10 | 1 | |
| 18 | 7.556 | 6 | 70 | 8.444 | 7.2 + 0.8* | 0 | 0.10 | 1 | |
| 19 | 21.000 | 6 | 50 | 14.000 | 8.1 + 0.9* | 0 | 0.20 | 1 | |
| 20 | 2.857 | 6 | 55 | 26.143 | 9.0 + 1.0* | 0 | 0.30 | 1 | |

*indicates a composition ratio of acid A + a composition ratio of acid E

TABLE 1-3
COMPOSITION

| | | PAINT COMPOSITION | | | | | | |
|---|---|---|---|---|---|---|---|---|
| | | METAL IONS (a) | | | | | | WATER DISPERSIBLE |
| | BLACK COLORED | | | | ANOTHER | | WATER SOLUBLE | ORGANIC RESIN (c) |
| EXAMPLE | STEEL SHEET | Al | Mg | Mn | TYPE | PATTERN | ORGANIC RESIN (b) | TYPE |
| 21 | A | H | C | P | Zn—C | B | C | A |
| 22 | A | H | C | P | Zn—C | B | C | A |
| 23 | A | H | C | P | Zn—C | B | C | A |
| 24 | A | H | C | P | Zn—C | B | C | A |
| 25 | A | H | C | P | Zn—C | B | C | A |
| 26 | A | — | — | — | — | — | — | A |
| 27 | A | H | C | P | Zn—C | B | C | — |
| 28 | A | H | C | P | Zn—C | B | C | A |
| 29 | A | H | C | P | Zn—C | B | C | A |

| | PAINT COMPOSITION | | | | | |
|---|---|---|---|---|---|---|
| | WATER DISPERSIBLE | | | | | |
| | ORGANIC RESIN (c) | | | | | |
| | AVERAGE PARTICLE | | GLYCOLURIL | | ORGANIC | |
| EXAMPLE | DIAMETER (μm) | Tg (° C.) | RESIN (d) | ACID (e) | ACID (f) | REMARKS |
| 21 | 0.16 | 50 | C | A | — | INVENTION |
| 22 | 0.16 | 60 | C | A | — | EXAMPLE |
| 23 | 0.16 | 50 | C | A | — | |
| 24 | 0.16 | 50 | C | A + E | — | |
| 25 | 0.16 | 50 | C | A | B | |
| 26 | 0.16 | 50 | — | A | B | COMPARATIVE |
| 27 | — | — | — | A + E | — | EXAMPLE |
| 28 | 0.16 | 50 | — | A | — | |
| 29 | 0.16 | 50 | — | A | — | |

“—” indicates the content is zero.
Another type of metal ions corresponds to the metal ions Me mentioned above.

TABLE 1-4
COMPOSITION RATIO

| | COMPOSITION RATIO OF PAINT COMPOSITION | | | | | | | | |
|---|---|---|---|---|---|---|---|---|---|
| | | WATER | WATER | | | | | COATING | |
| | METAL | SOLUBLE | DISPERSIBLE | | | | | FILM | |
| | IONS | ORGANIC | ORGANIC | GLYCOLURIL | ACID | ORGANIC | d/b + | THICKNESS | |
| EXAMPLE | (a) | RESIN (b) | RESIN (c) | RESIN (d) | (e) | ACID (f) | c + d | (mm) | REMARKS |
| 21 | 2.857 | 6 | 55 | 26.143 | 10 | 0 | 0.30 | 1 | INVENTION |
| 22 | 2.857 | 6 | 55 | 26.143 | 10 | 0 | 0.30 | 1 | EXAMPLE |
| 23 | 4.286 | 5 | 55 | 25.714 | 10 | 0 | 0.30 | 1 | |
| 24 | 4.286 | 5 | 55 | 25.714 | 9.0 + 1.0* | 0 | 0.30 | 1 | |
| 25 | 4.286 | 5 | 55 | 25.714 | 8 | 2 | 0.30 | 1 | |
| 26 | 0 | 0 | 85 | 0 | 10 | 5 | 0.00 | 1 | COMPARATIVE |
| 27 | 20 | 50 | 0 | 0 | 27.0 + 3.0* | 0 | 0.00 | 1 | EXAMPLE |
| 28 | 20 | 5 | 55 | 0 | 20 | 0 | 0.00 | 1 | |
| 29 | 20 | 5 | 55 | 0 | 20 | 0 | 0.00 | 3 | |

*indicates a composition ratio of acid A + a composition ratio of acid E

TABLE 2

| | CORRO- | CHANGE | | | | FINGER- | | | ELECTRO- | |
|---|---|---|---|---|---|---|---|---|---|---|
| | SION | IN | | BLOCKING | BENDING | PRINT | SCRATCH | SOLVENT | MAGNETIC | |
| EXAM- | RESIS- | COLOR | GLOSS | RESIS- | RESIS- | RESIS- | RESIS- | RESIS- | SHIELDING | |
| PLE | TANCE | TONE | VALUE | TANCE | TANCE | TANCE | TANCE | TANCE | PROPERTIES | REMARKS |
| 1 | ⊙ | ⊙ | ⊙ | ⊙ | ⊙ | ⊙ | ⊙ | ⊙ | ◯ | INVENTION |
| | | | | | | | | | | EXAMPLE |
| 2 | ⊙ | ⊙ | ⊙ | ⊙ | ⊙ | ⊙ | ⊙ | ⊙ | ◯ | INVENTION |
| | | | | | | | | | | EXAMPLE |
| 3 | ⊙ | ⊙ | ⊙ | ⊙ | ⊙ | ⊙ | ⊙ | ⊙ | ◯ | INVENTION |
| | | | | | | | | | | EXAMPLE |
| 4 | ⊙ | ⊙ | ⊙ | ⊙ | ⊙ | ⊙ | ⊙ | ⊙ | ◯ | INVENTION |
| | | | | | | | | | | EXAMPLE |
| 5 | ⊙ | ⊙ | ⊙ | ⊙ | ⊙ | ⊙ | ⊙ | ⊙ | ◯ | INVENTION |
| | | | | | | | | | | EXAMPLE |
| 6 | ◯ | ◯ | ⊙ | ⊙ | ⊙ | ◯ | ⊙ | ⊙ | ◯ | INVENTION |
| | | | | | | | | | | EXAMPLE |
| 7 | ⊙ | ⊙ | ⊙ | ⊙ | ⊙ | ⊙ | ⊙ | ⊙ | ◯ | INVENTION |
| | | | | | | | | | | EXAMPLE |
| 8 | ⊙ | ⊙ | ⊙ | ⊙ | ⊙ | ⊙ | ⊙ | ⊙ | ◯ | INVENTION |
| | | | | | | | | | | EXAMPLE |
| 9 | ⊙ | ⊙ | ⊙ | ⊙ | ⊙ | ⊙ | ⊙ | ⊙ | ◯ | INVENTION |
| | | | | | | | | | | EXAMPLE |
| 10 | ⊙ | ⊙ | ⊙ | ⊙ | ⊙ | ⊙ | ⊙ | ⊙ | ◯ | INVENTION |
| | | | | | | | | | | EXAMPLE |
| 11 | ⊙ | ⊙ | ⊙ | ⊙ | ⊙ | ⊙ | ⊙ | ⊙ | ◯ | INVENTION |
| | | | | | | | | | | EXAMPLE |
| 12 | ⊙ | ⊙ | ⊙ | ⊙ | ⊙ | ⊙ | ⊙ | ⊙ | ◯ | INVENTION |
| | | | | | | | | | | EXAMPLE |
| 13 | ⊙ | ⊙ | ⊙ | ⊙ | ⊙ | ⊙ | ⊙ | ⊙ | ◯ | INVENTION |
| | | | | | | | | | | EXAMPLE |
| 14 | ⊙ | ⊙ | ⊙ | ⊙ | ⊙ | ⊙ | ⊙ | ⊙ | ◯ | INVENTION |
| | | | | | | | | | | EXAMPLE |
| 15 | ⊙ | ⊙ | ⊙ | ⊙ | ⊙ | ⊙ | ⊙ | ⊙ | ◯ | INVENTION |
| | | | | | | | | | | EXAMPLE |
| 16 | ⊙ | ⊙ | ⊙ | ⊙ | ⊙ | ⊙ | ⊙ | ⊙ | ◯ | INVENTION |
| | | | | | | | | | | EXAMPLE |
| 17 | ⊙ | ⊙ | ⊙ | ⊙ | ⊙ | ⊙ | ⊙ | ⊙ | ◯ | INVENTION |
| | | | | | | | | | | EXAMPLE |
| 18 | ⊙ | ⊙ | ⊙ | ⊙ | ⊙ | ⊙ | ⊙ | ⊙ | ◯ | INVENTION |
| | | | | | | | | | | EXAMPLE |
| 19 | ⊙ | ⊙ | ⊙ | ⊙ | ⊙ | ⊙ | ⊙ | ⊙ | ◯ | INVENTION |
| | | | | | | | | | | EXAMPLE |
| 20 | ⊙ | ⊙ | ⊙ | ⊙ | ⊙ | ⊙ | ⊙ | ⊙ | ◯ | INVENTION |
| | | | | | | | | | | EXAMPLE |
| 21 | ⊙ | ⊙ | ⊙ | ⊙ | ⊙ | ⊙ | ⊙ | ⊙ | ◯ | INVENTION |
| | | | | | | | | | | EXAMPLE |
| 22 | ⊙ | ⊙ | ⊙ | ⊙ | ⊙ | ⊙ | ⊙ | ⊙ | ◯ | INVENTION |
| | | | | | | | | | | EXAMPLE |
| 23 | ⊙ | ⊙ | ⊙ | ⊙ | ⊙ | ⊙ | ⊙ | ⊙ | ◯ | INVENTION |
| | | | | | | | | | | EXAMPLE |
| 24 | ⊙ | ⊙ | ⊙ | ⊙ | ⊙ | ⊙ | ⊙ | ⊙ | ◯ | INVENTION |
| | | | | | | | | | | EXAMPLE |
| 25 | ⊙ | ⊙ | ⊙ | ⊙ | ⊙ | ⊙ | ⊙ | ⊙ | ◯ | INVENTION |
| | | | | | | | | | | EXAMPLE |
| 26 | X | X | X | X | X | X | X | X | ◯ | COMPARATIVE |
| | | | | | | | | | | EXAMPLE |
| 27 | X | X | Δ | ◯ | ◯ | ◯ | ◯ | X | ◯ | COMPARATIVE |
| | | | | | | | | | | EXAMPLE |
| 28 | ⊙ | ⊙ | ⊙ | ⊙ | ⊙ | ⊙ | ⊙ | X | ◯ | COMPARATIVE |
| | | | | | | | | | | EXAMPLE |
| 29 | ⊙ | ⊙ | ⊙ | ⊙ | ⊙ | ⊙ | ⊙ | X | X | COMPARATIVE |
| | | | | | | | | | | EXAMPLE |

1. A black colored steel sheet comprising: a Zn—Ni plating steel sheet which is processed by blackening treatment; and a coating film formed on a surface of the Zn—Ni plating steel sheet by applying a paint composition which contains (a) metal ions, (b) a water soluble organic resin, (c) a water dispersible organic resin, (d) a glycoluril resin, and (e) an acid.

2. The black colored steel sheet according to claim 1, wherein the metal ions (a) are at least one type selected from the group consisting of Al ions, Mg ions, and Mn ions.

3. The black colored steel sheet according to claim 1, wherein the metal ions (a) comprises at least one type selected from the group consisting of Al ions, Mg ions, and Mn ions and ions of at least one metal selected from the group consisting of Zn, Co, Ti, Sn, Ni, Fe, Zr, Sr, Y, Nb, Cu, Ca, V, and Ba.

4. The black colored steel sheet according to claim 1, wherein the addition amount of the metal ions (a) to the total of the metal ions (a), the water soluble organic resin (b), the water dispersible organic resin (c), the glycoluril resin (d), and the acid (e) is in the range of 0.1 to 50 mass percent.

5. The black colored steel sheet according to claim 1, wherein the water soluble organic resin (b) comprises at least one type of polymer of a monomer containing a carboxyl group and/or at least one type of copolymer of a monomer containing a carboxyl group and another polymeric monomer.

6. The black colored steel sheet according to claim 1, wherein the addition amount of the water soluble organic resin (b) to the total of the metal ions (a), the water soluble organic resin (b), the water dispersible organic resin (c), the glycoluril resin (d), and the acid (e) is in the range of 0.1 to 20 mass percent.

7. The black colored steel sheet according to claim 1, wherein the addition amount of the water dispersible resin (c) to the total of the metal ions (a), the water soluble organic resin (b), the water dispersible organic resin (c), the glycoluril resin (d), and the acid (e) is in the range of 40 to 80 mass percent.

8. The black colored steel sheet according to claim 1, wherein the addition amount of the glycoluril resin (d) to the total of the metal ions (a), the water soluble organic resin (b), the water dispersible organic resin (c), the glycoluril resin (d), and the acid (e) is in the range of 1 to 40 mass percent.

9. The black colored steel sheet according to claim 1, wherein the acid (e) is at least one selected from the group consisting of phosphoric acid, acetic acid, nitric acid, hydrofluoric acid, and vanadic acid.

10. The black colored steel sheet according to claim 1, wherein the acid (e) comprises an organic acid which can be coordinated with a metal of bivalence or more and at least one selected from the group consisting of phosphoric acid, acetic acid, nitric acid, hydrofluoric acid, and vanadic acid.

11. The black colored steel sheet according to claim 1, wherein the addition amount of the acid (e) to the total of the metal ions (a), the water soluble organic resin (b), the water dispersible organic resin (c), the glycoluril resin (d), and the acid (e) is in the range of 1 to 20 mass percent.

12. The black colored steel sheet according to claim 1, wherein the coating film has a thickness of 0.1 to 3 μm.
